(19) United States
(12) Patent Application Publication
(10) Pub. No.: US 2023/0102918 A1
(43) Pub. Date: Mar. 30, 2023

(54) System and Method for Order Retrieval

(71) Applicant: Driving Thru Inc., Calabasas, CA (US)

(72) Inventors: Scott Siegel, Calabasas, CA (US); Kevin Pidduck, Ventura, CA (US); Aaron Werber, Agoura Hills, CA (US)

(21) Appl. No.: 17/991,328

(22) Filed: Nov. 21, 2022

Related U.S. Application Data
(63) Continuation-in-part of application No. 16/798,083, filed on Feb. 21, 2020.

(51) Int. Cl. G06Q 30/06; G06Q 10/08; G06Q 50/12; G01C 21/34

(52) U.S. Cl. CPC G06Q 30/0635; G01C 21/3407; G06Q 10/087; G06Q 50/12

(57) ABSTRACT

A system and method for order retrieval is provided. In some embodiments, the system may comprise a mobile computing device associated with a customer and a computing device associated with a business, such as a restaurant or retail store. The customer mobile computing device may receive identity information associated with the customer, generate a menu, receive an order, provide navigational directions to a delivery zone, receive a preparation timeframe notification, and detect and transmit a preparation timeframe arrival and subsequently, a delivery zone arrival and location of the customer. The business computing device may receive the identity information and the order, adjust a preparation timeframe and the delivery zone, transmit the preparation timeframe notification, receive and display the preparation timeframe arrival and the delivery zone arrival, and complete the order. In further exemplary embodiments, the system may also comprise a printer connected to the business computing device. The printer may receive the identity information and the order and print at least one ticket.

### GOVERNMENT CONTRACT

Not applicable.

### CROSS REFERENCE TO RELATED APPLICATIONS

Pursuant to 35 U.S.C. § 120, this Patent Application relies on the benefit of U.S. Pat. App. No. 16/798,083 filed on Feb. 21, 2020. The content of said application is incorporated herein by reference in its entirety.

### STATEMENT RE. FEDERALLY SPONSORED RESEARCH/DEVELOPMENT

Not applicable.

### COPYRIGHT & TRADEMARK NOTICES

A portion of the disclosure of this patent document may contain material which is subject to copyright protection. This patent document may show and/or describe matter which is or may become trade dress of the owner. The copyright and trade dress owner has no objection to the facsimile reproduction by any one of the patent document or the patent disclosure, as it appears in the Patent and Trademark Office patent files or records, but otherwise reserves all copyrights and trade dress rights whatsoever.

### TECHNICAL FIELD

The disclosed subject matter relates generally to order retrieval systems and methods and, more particularly, to an order retrieval system and method wherein a customer’s arrival within an adjustable preparation timeframe and subsequently, a customizable delivery zone, is transmitted to a business so as to increase efficiency and ease with which orders are delivered to the customer.

### BACKGROUND

With the continuous advent of advanced technology, including software applications available in the palm of one’s hand via a mobile device, such as a smartphone, people desire products and services as quickly as possible. While drive through restaurants have long provided one solution, such establishments are insufficient to satisfy all needs. One deficiency is that they are limited primarily to unhealthy “fast food” restaurants and liquor stores. Another solution offered by some restaurants and retail stores is the designation of parking spaces for “To Go” orders, which allows customers to quickly park and enter a business to retrieve an order. Moreover, some businesses even offer curbside pickup by designating parking spaces for the same and instructing customers to call upon arrival. However, these establishments are also lacking because there inevitably remains a waiting period prior to the customer receiving the order. In addition, there is usually an extremely limited number of “To Go” or curbside pickup parking spaces designated, forcing customers to spend extra time searching for parking. To make matters worse, in crowded urban areas, such as Los Angeles, there is limited availability of parking in general. Thus, there remains a need to optimize customer order retrieval by minimizing the amount of time the customer spends in between arriving at a business and receiving their order.

Further attempts have been made to address this need and desire for easy and efficient order retrieval. For example, U.S. Pat. No. 7,974,873 (the “'873 Patent”) teaches employing just in time pick up or delivery by a mobile customer. In the ‘873 Patent, a mobile customer places an order for at least one good or service and then a merchant who may be able to provide the requested good and/or service is selected. This disclosure does not allow a customer to pre-select at particular merchant for their order but instead, the merchant is dynamically selected based on attempting to minimize a wait time for the user to pick up or otherwise receive the order. Thus, the customer is likely limited to a specific number of merchants who are capable of fulfilling an order within a specified time period.

Another attempt can be seen with regard to U.S. Pat. Application Publication No. 20190342718 (the “'718 Publication”). The ‘718 Publication discloses “smart location determination for arrival estimation and generation of arrival alerts.” This purported invention seeks to reduce the amount of computations performed at a server site by only alerting the destination (i.e. restaurant, store, etc.) of the customer’s arrival at a threshold time ahead of said arrival. This disclosure is deficient, however, because the destination is only notified when the customer is within a particular threshold rather than a continuous update of the customer’s location, regardless of whether they have passed a threshold. Moreover, the ‘718 Publication disallows a customizable destination where the delivery will be received by the customer but instead, provides the restaurant or store as the destination to which the customer is to travel. In this manner, the ‘718 Publication inadequately decreases the time between order placement and order retrieval.

As a final example, U.S. Pat. Application Publication No. 20160155088 (the “'088 Publication”) describes a “limited location tracking of a user device for local pick up,” which essentially describes local/near-the-store pick up for an order. However, in order to minimize user tracking, the ‘088 Publication only begins sharing the user’s location at a first threshold distance, which does not appear to be customizable depending on the type of order. Because the first threshold distance is pre-determined and therefore, may not vary with varying types of orders, traffic conditions, or other factors, the ‘088 offers an inadequate solution to efficient order retrieval.

As a result, there remains a need for easy and efficient order retrieval. More particularly, there remains a need for a reliable means of minimizing time between order placement and order retrieval.

### SUMMARY

The present disclosure is directed to an order retrieval system and method, which provides for at least two computing devices capable of detecting a customer’s arrival and notifying a business of the arrival so as to efficiently provide the customer with an order. In many embodiments, and for purposes of brevity, the system and method for order retrieval wherein a business comprises a restaurant or retail store is shown and described, however, it will be understood that the “business” may include virtually any type of business, including those that provide services rather than goods. Moreover, in many embodiments, the customer may be an individual or another business for which the order is intended. In other embodiments, the customer may be a third party, such as a third-party delivery service, which may retrieve the order and subsequently deliver the order to the individual for whom it is intended. For purposes of brevity, each of the aforementioned recipients of the order will hereafter be referred to as the “customer.”

For purposes of summarizing, certain aspects, advantages, and novel features have been described. It is to be understood that not all such advantages may be achieved in accordance with any one particular embodiment. Thus, the disclosed subject matter may be embodied or carried out in a manner that achieves or optimizes one advantage or group of advantages without achieving all advantages as may be taught or suggested.

In accordance with one embodiment, an order retrieval system is provided that may utilize a mobile computing device associated with a customer and a computing device associated with a business. The mobile computing device associated with the customer (variously referred to as “customer mobile computing device” or “customer computing device”) may be operative to receive identity information associated with the customer. The identity information may comprise personal information or vehicular information. In some embodiments, the identity information may allow the business to locate the customer when the order is ready. In other embodiments, the identity information may allow the business to charge the customer for the order. The customer mobile computing device may be further operative to generate a menu comprising one or more items associated with the business. For instance, the one or more items may be edible items, such as food or beverages, that the business offers for sale. The customer computing device may also be operative to receive the order from the customer, and the order may comprise at least one of the one or more items. In turn, the customer computing device may be operative to transmit the order to the business.

In certain embodiments, the customer mobile computing device may be operative to navigate the customer to the business. More particularly, the mobile computing device may be operative to detect an initial location associated with the customer. The initial location may be the customer’s residence or a location where the customer is present. In some embodiments, the customer may be routed, that is, provided with navigational directions, from the initial location to a delivery zone, which may be the business itself or a nearby parking area, such as a parking lot or parking garage, at which the order may be received by the customer. Moreover, the customer computing device may be operative to display the delivery zone.

The customer mobile computing device may also be operative to receive a preparation timeframe notification from the business. In some embodiments, the customer mobile computing device may be operative to navigate the customer to be business based on the preparation timeframe notification. By way of example, the customer computing device may provide longer navigational directions to the business if the preparation timeframe notification corresponds to a later preparation timeframe. Alternatively, the customer computing device may provide shorter navigational directions to the business if the preparation timeframe notification corresponds to an earlier preparation timeframe.

The customer mobile computing device may be further operative to detect a preparation timeframe arrival of the customer and transmit the preparation timeframe arrival to the business. Thereafter, the customer mobile computing device may be operative to detect a delivery zone arrival of the customer and a delivery zone location of the customer. The delivery zone location may be the global positioning system (GPS) coordinates of the customer within the delivery zone. In certain embodiments, the delivery zone may be a parking space in which the customer is located. The mobile computing device associated with the customer may then be operative to transmit the delivery zone arrival and the delivery zone location to the business.

The computing device associated with the business (also referred to as the “business computing device”) may be operative to receive the identity information and the order from the customer mobile computing device. The business computing device may adjust a preparation timeframe, which may comprise the amount of time required by the business to prepare the order. Thus, the preparation timeframe may be adjusted upward if the order contains more items or downward if the order contains less items. In addition, the preparation timeframe may be adjusted depending on a level of difficulty associated with preparing each of the one or more items. Further, the preparation timeframe may be adjusted in real-time based on one or more preparation status updates from the business. In alternate embodiments, the preparation timeframe may be set to a default preparation timeframe, which may comprise the amount of time required by the business to prepare a typical order.

Based on the preparation timeframe, the business computing device may be further operative to transmit the preparation timeframe notification to the customer. In some instances, the business computing device may be operative to transmit more than one preparation timeframe notifications to the customer based on adjustments of the preparation timeframe and, in turn, the one or more preparation status updates from the business. Alternatively, the business computing device may be operative to transmit only one preparation timeframe notification to the customer.

The business computing device may also be operative to adjust the delivery zone. As discussed previously, the delivery zone may comprise the GPS coordinates of the business or another location nearby the business, such as an open curb or parking space. In addition, in some embodiments, the delivery zone may comprise a range of GPS coordinates, such as that associated with a parking lot, a parking garage, or an open curb with numerous parking spaces. In other embodiments, the delivery zone may comprise a range defined by four or more individually selected GPS coordinates. The four or more individually selected GPS coordinates may be selected by the business. In any event, the business may adjust the delivery zone based on ease of access thereto from the business.

In certain embodiments, the computing device associated with the business may be operative to receive the preparation timeframe arrival from the mobile computing device and display a preparation timeframe arrival notification. In some embodiments, the preparation timeframe arrival notification may allow the business sufficient time within which the order is to be prepared. The order may be deemed ready when each of the one or more items has been prepared and packaged by the business.

The business computing device may also be operative to receive the delivery zone arrival and the delivery zone location and thereafter, display a delivery zone arrival notification and the delivery zone location. The delivery zone arrival notification may allow the business sufficient time to bring the order to the delivery zone location, where the customer is located. Finally, the business computing device may be operative to complete the order. In certain embodiments, the order may be completed when the business indicates the customer has retrieved the order or the order has been placed in a retrieval location.

In some embodiments, such as when the business has not yet completed preparation of the order, the business computing device may be further operative to receive a future delivery input from the business. In such embodiments, the business computing device may be even further operative to display a customer waiting timer. The customer waiting timer may indicate an amount of time the customer has been located in the delivery zone.

In other embodiments, such as when the business has completed preparation of the order but cannot locate the customer in the delivery zone, the business computing device may be further operative to receive and transmit a customer locating input. In these embodiments, the customer mobile computing device may be further operative to receive the customer locating input and display a customer locating notification. The customer locating notification may indicate one or more locating steps, such as flashing vehicle hazard lights.

In some exemplary embodiments, the system may further comprise a printer, which may be connected to the business computing device. In such embodiments, the business computing device may be further operative to transmit the identity information and the order to the printer. The printer may be operative to receive the identity information and the order and print at least one ticket. The at least one ticket may comprise the identity information and the order. Of course, in some embodiments, the printer may be operative to print a plurality of tickets, one or more of which may comprise the identity information, the order, and/or a quantity of the one or more items. Moreover, in certain embodiments, the printer may be operative to automatically print the at least one ticket responsive to the preparation timeframe arrival.

In certain embodiments, the business computing device may be further operative to adjust operating hours. The operating hours may comprise one or more hours during which the business is able and willing to receive the order. In some embodiments, the business may adjust the operating hours for each day of a week or may set the operating hours to be the same for each day. In other embodiments, the business may manually turn off the operating hours in real-time.

In further embodiments, the method may further comprise the steps of providing a mobile computing device associated with a customer and a computing device associated with a business; receiving, at the customer mobile computing device, identity information associated with the customer; generating, at the customer mobile computing device, a menu computing one or more items associated with the business; receiving, at the customer mobile computing device, an order comprising at least one of the one or more items; transmitting, at the customer mobile computing device, the identity information and the order to the business; detecting, at the customer mobile computing device, an initial location associated with the customer; receiving, at the customer mobile computing device, a preparation timeframe notification from the business; providing, at the customer mobile computing device, navigational directions from the initial location to a delivery zone; detecting, at the customer mobile computing device, a preparation timeframe arrival of the customer; transmitting, at the customer mobile computing device, the preparation timeframe arrival to the business; detecting, at the customer mobile computing device, a delivery zone arrival of the customer; detecting, at the customer mobile computing device, a delivery zone location of the customer; transmitting, at the customer mobile computing device, the delivery zone arrival and the delivery zone location to the business; receiving, at the business computing device, the identity information and the order; adjusting, at the business computing device, a preparation timeframe; transmitting, at the business computing device, the preparation timeframe notification to the customer based on the preparation timeframe; adjusting, at the business computing device, the delivery zone; receiving, at the business computing device, the preparation timeframe arrival; displaying, at the business computing device, a preparation timeframe arrival notification; receiving, at the business computing device, the delivery zone arrival and the delivery zone location; displaying, at the business computing device, a delivery zone arrival notification and the delivery zone location; and completing, at the business computing device, the order.

In these embodiments, receiving identity information associated with the customer may comprise receiving the identity information directly from the customer or from the customer mobile computing device, or one or more applications stored thereon. For instance, the mobile computing device may receive the identity information from a social media account associated with the customer. When the identity information is transmitted to the business, the business may utilize the identity information in order to complete the order, that is, in order to deliver the proper order to the proper customer.

The customer mobile computing device may provide navigational directions from the initial location to the delivery zone. In so doing, the customer mobile computing device may provide navigational directions directly or may link to another application wherein the navigational directions may be provided. The navigational directions may further comprise a route, which may comprise the path along which the customer may travel to the delivery zone. The initial location may comprise an address associated with the customer, such as a residence or a business address. The delivery zone may comprise an address associated with the business, such as a place of business (e.g., restaurant or storefront) or a parking area adjacent or near to the business.

The mobile computing device may further detect a preparation timeframe arrival of the customer and transmit the preparation timeframe arrival to the business. In turn, the business computing device may receive the preparation timeframe arrival and display the preparation timeframe arrival notification. The preparation timeframe arrival may be triggered when the customer is physically present at a GPS coordinate along the route such that the customer is a predetermined amount of time away from the delivery zone. A preparation timeframe may comprise the aforesaid predetermined amount of time. In some embodiments, the business computing device may display the preparation timeframe arrival notification so as to allow the business sufficient time to prepare the order within the preparation timeframe. Sometimes, to prepare the order, the business may prepare and package the one or more items of the order. In certain embodiments, wherein the one or more items may be one or more edible items, the preparation timeframe may comprise an amount of time needed to cook or otherwise prepare the one or more edible items. In other embodiments, the business computing device may receive a location, that is, a GPS coordinate along the route, of the customer continuously as the customer travels along the route to the business.

The customer mobile computing device may also detect the delivery zone arrival and the delivery zone location and transmit the same to the business. In turn, the business computing device may receive the delivery zone arrival and the delivery zone location and may further display the delivery zone arrival notification and the delivery zone location. Similar to the preparation timeframe arrival, the delivery zone arrival may be triggered when the customer is physically present at any GPS coordinate within the delivery zone. Further, the delivery zone location may comprise a GPS coordinate of the customer within the delivery zone. In some embodiments, the delivery zone location may comprise a parking space within the delivery zone.

Finally, the business computing device may complete the order. Completing the order may comprise delivering the order to the customer. In other embodiments, completing the order may comprise delivering the order to the customer and charging the customer for the one or more items. In still other embodiments, completing the order may comprise transmitting a rating request to the customer.

In alternate embodiments, wherein the order has not yet been prepared by the business and, therefore, prior to the business computing device completing the order, the method may further comprise the steps of: receiving, at the business computing device, a future delivery input; and displaying, at the business computing device, a customer waiting timer. In still other embodiments, wherein the business is unable to locate the customer within the delivery zone, and therefore, prior to the business computing device completing the order, the method may further comprise the steps of: receiving, at the business computing device, a customer locating input; transmitting, at the business computing device, the customer locating input; receiving, at the customer mobile computing device, the customer locating input; and displaying, at the customer mobile computing device, a customer locating notification.

In further embodiments, the method may further comprise the steps of: providing the printer connected to the computing device associated with the business; transmitting, at the business computing device, the identity information and the order to the printer; receiving, the printer, the identity information and the order; and printing, at the printer, at least one ticket.

One or more of the above-disclosed embodiments, in addition to certain alternatives, are provided in further detail below with reference to the attached figures. The disclosed subject matter is not, however, limited to any particular embodiment disclosed.

### BRIEF DESCRIPTION OF THE DRAWINGS

FIG. 1 shows an embodiment of the order retrieval system.

FIG. 2 shows an embodiment of the order retrieval method.

FIG. 3 shows an embodiment of the order retrieval method.

FIG. 4 shows an embodiment of the order retrieval method.

FIG. 5 shows an embodiment of the order retrieval system.

FIG. 6 shows an embodiment of the order retrieval system.

One embodiment of the invention is implemented as a program product for use with a computer system. The program(s) of the program product defines functions of the embodiments (including the methods described herein) and can be contained on a variety of computer-readable storage media. Illustrative computer-readable storage media include, but are not limited to: (i) non-writable storage media (e.g., read-only memory devices within a computer such as CD-ROM disks readable by a CD-ROM drive) on which information is permanently stored; (ii) writable storage media (e.g., floppy disks within a diskette drive or hard-disk drive) on which alterable information is stored. Such computer-readable storage media, when carrying computer-readable instructions that direct the functions of the present invention, are embodiments of the present invention. Other media include communications media through which information is conveyed to a computer, such as through a computer or telephone network, including wireless communications networks. The latter embodiment specifically includes transmitting information to/from the Internet and other networks. Such communications media, when carrying computer-readable instructions that direct the functions of the present invention, are embodiments of the present invention. Broadly, computer-readable storage media and communications media may be referred to herein as computer-readable media.

In general, the routines executed to implement the embodiments of the invention, may be part of an operating system or a specific application, component, program, module, object, or sequence of instructions. The computer program of the present invention typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

For simplicity and clarity of illustration, the drawing figures illustrate the general manner of construction, and descriptions and details of well-known features and techniques may be omitted to avoid unnecessarily obscuring the invention. Additionally, elements in the drawing figures are not necessarily drawn to scale. For example, the dimensions of some of the elements in the figures may be exaggerated relative to other elements to help improve understanding of embodiments of the present invention. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus

The terms “couple,” “coupled,” “couples,” “coupling,” and the like should be broadly understood and refer to connecting two or more elements or signals, electrically, mechanically or otherwise. Two or more electrical elements may be electrically coupled, but not mechanically or otherwise coupled; two or more mechanical elements may be mechanically coupled, but not electrically or otherwise coupled; two or more electrical elements may be mechanically coupled, but not electrically or otherwise coupled. Coupling (whether mechanical, electrical, or otherwise) may be for any length of time, e.g., permanent or semi-permanent or only for an instant.

### DETAILED DESCRIPTION

Having summarized various aspects of the present disclosure, reference will now be made in detail to that which is illustrated in the drawings. While the disclosure will be described in connection with these drawings, there is no intent to limit it to the embodiment or embodiments disclosed herein. Rather, the intent is to cover all alternatives, modifications and equivalents included within the spirit and scope of the disclosure as defined by the appended claims.

A system and method for order retrieval is provided that, in some embodiments, may allow a business to customize a delivery zone within which a customer may receive an order and detect a preparation timeframe arrival of the customer, thereby increasing the ease and efficiency of providing the order to the customer. The system and method may involve the business being a restaurant or a retail store. However, the term “business” is used throughout the remainder of this disclosure and should be understood to include any type of purveyor of goods and/or services.

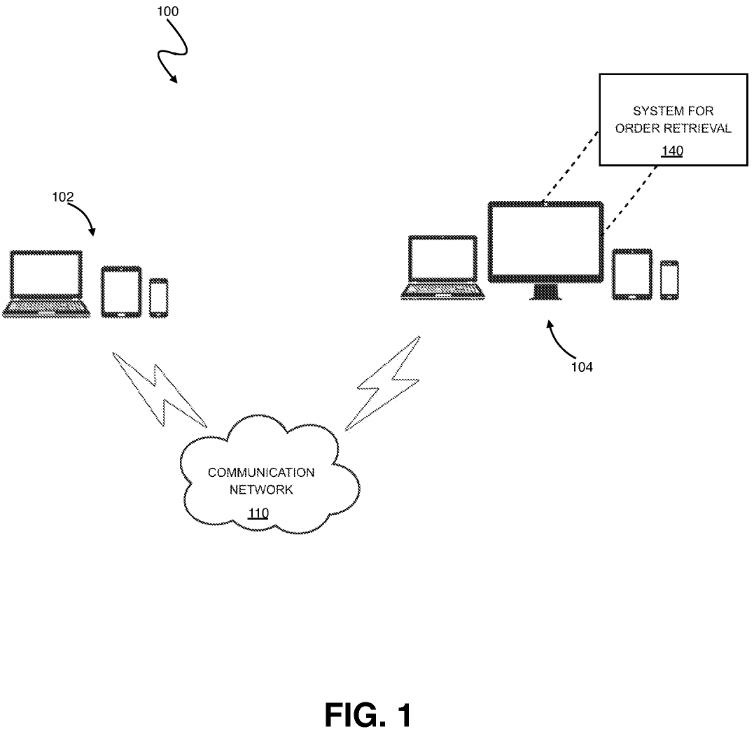

FIG. 1 is illustrative of a networked environment 100 in which an exemplary embodiment of an order retrieval system is implemented. As shown in FIG. 1, system 140 may comprise a mobile computing device associated with the customer 102 (alternatively, “customer mobile computing device” or “mobile computing device”) and a computing device associated with the business 104 (alternatively, “business computing device”). By way of example, and not limitation, the customer mobile computing device 102 and the business computing device 104 are shown communicatively coupled via a communication network 110. The mobile computing device 102 may be embodied as a smartphone, tablet, or laptop computer that incorporates Wi-Fi functionality and/or cellular telephone functionality. The business computing device 102 may be embodied as a desktop, laptop, tablet, or even smartphone, computer that incorporates Wi-Fi, wired, or cellular telephone, functionality. Notably, the communications network 110 may use one or more of various communication types such as, for example and without limitation, wired, cellular and Wi-Fi communications. Moreover, each of the mobile computing device 102 and the business computing device 104 may be coupled to a power supply, which may be effectuated by way of a power cord, battery, and/or other means of supplying electrical power as may be available or otherwise desired.

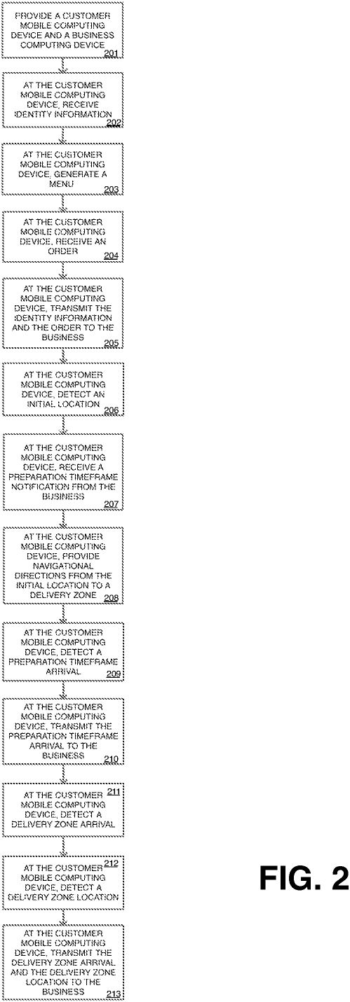

The mobile computing device 102 and the business computing device 104 may become members of a network that enables each to interact with one another and exchange information, such as identity information associated with the customer and an order, which may comprise one or more items. In this exemplary embodiment, the network may be facilitated by a website that is hosted by a network server. As such, the server may facilitate interaction among a limited group of members, as may be established by the members themselves. For the purpose of the example presented in FIG. 1, the limited group of members may include the mobile computing device 102 and the business computing device 104. Additionally, server may implement the system for order retrieval and facilitate sharing information relating to order retrieval. Specifically, the server may implement the steps outlined in FIG. 2. Accordingly, members of the network 110 may access the server using their devices 102 and 104 to obtain information, input information, and receive notifications, such as text messages and push notifications regarding order status and customer location (including a preparation timeframe arrival, a delivery zone arrival, and a delivery zone location).

In some embodiments, the customer mobile computing device 102 may be operative to receive the identity information associated with the customer. The identity information may comprise personal information and/or vehicular information. Personal information may comprise a name, a telephone number, an electronic mail address, financial information (e.g., credit card number, debit card number, bank account number and routing number), or other identifying information associated with the customer. Vehicular information may comprise a vehicular make (e.g., Porsche), a vehicular model (e.g., 911 Turbo), a color, or a license plate number. The identity information may enable the business to locate the customer when the order is ready for retrieval.

The customer mobile computing device 102 may be further operative to generate a menu, which may comprise one or more items associated with the business. In embodiments where the business is a restaurant, the one or more items may comprise edible items, such as food or beverages, that the business offers for sale. In embodiments where the business is a retail store, the one or more items may comprise retail items, such as clothing, cosmetics, or footwear. A person of ordinary skill in the art will recognize that the one or more items may comprise virtually any product or service capable of sale. Indeed, in some embodiments, the one or more items may comprise services or even, a combination of services and goods. The mobile computing device 102 may also be operative to receive the order from the customer. The order may comprise at least one of the one or more items from the menu. In turn, the customer computing device 102 may be operative to transmit the identity information and the order to the business.

In accordance with some embodiments, the mobile computing device 102 may be operative to navigate the customer to the business. The mobile computing device 102 may be operative to detect an initial location associated with the customer. The initial location may be a residence associated with the customer. In other embodiments, the initial location may be a business address or a temporary address, such as a hotel, associated with the customer. The customer computing device 102 may be further operative to provide navigational directions from the initial location to a delivery zone. The delivery zone may comprise an address associated with the business, such as the business address, a parking lot, or a parking garage. In alternate embodiments, the delivery zone may comprise any one or more GPS coordinates, regardless of whether the one or more GPS coordinates are associated with the business. One of ordinary skill in the art will recognize that the delivery zone may comprise virtually any GPS coordinate(s) selected by the business. The customer mobile computing device 102 may also be operative to display the delivery zone.

In certain embodiments, the mobile computing device 102 may be further operative to receive a preparation timeframe notification from the business. The preparation timeframe notification may be based on the preparation timeframe, which may be adjusted based on a minimum amount of time needed for the business to prepare the order. In other embodiments, the preparation timeframe may be adjusted based on one or more preparation status updates from the business. In further of such embodiments, the navigational directions may be adjusted based on the preparation timeframe notification and, in turn, the one or more preparation status updates from the business. In particular, the navigational directions may be adjusted temporally upward if the one or more preparation status updates indicate a later preparation timeframe, or downward if the one or more preparation status updates indicate an earlier preparation timeframe.

The customer mobile computing device 102 may be operative to detect a preparation timeframe arrival of the customer. The preparation timeframe arrival may be associated with a preparation timeframe. The preparation timeframe may comprise a minimum amount of time required by the business to prepare the order. The preparation timeframe arrival may occur when the customer is physically present within a GPS coordinate(s) wherein the customer is the minimum amount of time away from the delivery zone. Indeed, the business may adjust the preparation timeframe based on the one or more items in the order. In other embodiments, the business may set the preparation timeframe to a default preparation timeframe, which may comprise the amount of time required by the business to prepare a typical order. In turn, the customer mobile computing device 102 may be operative to transmit the preparation timeframe arrival to the business.

As with the preparation timeframe arrival, the customer mobile computing device 102 may similarly be operative to detect a delivery zone arrival of the customer and a delivery zone location of the customer. As discussed previously, the delivery zone may comprise one or more GPS coordinates, which may be selected by the business. Further, the delivery zone may comprise a range defined by four or more individually selected GPS coordinates, which may be selected by the business. The delivery zone arrival may occur when the customer is physically present within at least one GPS coordinate within the delivery zone. The delivery zone location may comprise GPS coordinates of the customer within the delivery zone. In certain embodiments, the delivery zone location may comprise one or more parking spaces where the customer is parked. The mobile computing device 102 may be further operative to transmit the delivery zone arrival and the delivery zone location to the business.

The business computing device 104 may be operative to receive the identity information and the order from the customer mobile computing device 102. Based on the one or more items of the order, the business computing device 104 may be operative to adjust the preparation timeframe. The business computing device 104 may be operative to adjust the preparation timeframe based on an a minimum amount of time needed for the business to prepare the order. Specifically, if the one or more items of the order are numerous or complicated, the business computing device 104 may be operative to adjust the preparation timeframe upward. On the other hand, if the one or more items of the order are minimal or simple, the business computing device 104 may be operative to adjust the preparation timeframe downward. In still alternate embodiments, the business computing device 104 may be operative to adjust the preparation timeframe based on one or more preparation status updates from the business. Moreover, the one or more preparation status updates may be provided in real-time.

The business computing device 104 may be further operative to transmit the preparation timeframe notification to the customer based on the preparation timeframe. In some embodiments, the business computing device 104 may be operative to transmit more than one preparation timeframe notification to the customer, such as in embodiments wherein the one or more preparation status updates may comprise more than one preparation status update. In other embodiments, the business computing device 104 may be operative to transmit only one preparation timeframe notification to the customer.

In accordance with certain embodiments, the business computing device 104 may be operative to adjust the delivery zone, that is, the delivery zone may be customizable by the business. In particular, the business computing device 104 may be operative to adjust the delivery zone so as to comprise any one or more GPS coordinates. For example, the delivery zone may comprise one or more GPS coordinates associated with a parking lot or garage nearby or adjacent to the business. As another example, the delivery zone may comprise one or more GPS coordinates associated with a curb nearby or adjacent to the business. As desired, the delivery zone may comprise virtually any one or more GPS coordinates as selected by the business.

The business computing device 104 may be further operative to receive the preparation timeframe arrival from the customer computing device 102 and display a preparation arrival notification. The preparation timeframe arrival and the preparation timeframe arrival notification may alert the business that the minimum amount of time needed to prepare the order has commenced. The business computing device 104 may be operative to receive the delivery zone arrival and the delivery zone location. In turn, the business computing device 104 may be operative to display a delivery zone arrival notification and the delivery zone location. The delivery zone arrival notification may alert the business that the customer is located within the delivery zone. Moreover, the delivery zone arrival notification may be displayed by the business computing device 104 when the customer is physically present within a range of GPS coordinates wherein the business will have sufficient time to deliver the order to the customer. The delivery zone location may alert the business as to one or more GPS coordinates of the customer within the delivery zone.

In some embodiments of the present invention, the business computing device 104 may be further operative to complete the order. The business computing device 104 may be operative to complete the order when the customer has received the order. In other embodiments, the business computing device 104 may be operative to complete the order when the order has been placed in a retrieval location accessible by the customer. In still other embodiments, the business computing device 104 may be operative to complete the order when the customer has been charged and a rating request has been transmitted to the customer.

In certain embodiments, such as when the business has not yet completed preparation of the order or one or more of the one or more items of the order, the business computing device 104 may be further operative to receive a future delivery input from the business. In turn, the business computing device 104 may also be operative to display a customer waiting timer. The customer waiting timer may indicate an amount of time the customer has been located in the delivery zone. In other embodiments, the customer waiting timer may indicate an amount of time that has passed since the customer was promised the order.

In embodiments where the business is unable to locate the customer within the delivery zone, the business computing device 104 may be further operative to receive a customer locating input. The business computing device 104 may then be operative to transmit the customer locating input to the customer computing device 102. As such, the customer computing device 102 may be operative to receive the customer locating input and display a customer locating notification. The customer locating notification may indicate one or more locating steps. The one or more locating steps may provide the customer with information about how to identify themselves within the delivery zone. For example, the one or more locating steps may comprise flashing vehicle hazard lights or standing outside of the vehicle.

In alternate embodiments, the system may further comprise a printer connected to the business computing device 104. In such embodiments, the business computing device 104 may be further operative to transmit the identity information and the order to the printer. The printer may be operative to receive the identity information and the order and print at least one ticket comprising the identity information and the order. In some embodiments, the at least one ticket may comprise a first ticket and a second ticket. For example, the first ticket may comprise the identity information, such as a customer name and vehicular information, and a quantity of the one or more items of the order, or an item name for each of the one or more items of the order. Following this example, the second ticket may comprise the one or more items of the order. As another example, in certain embodiments, the at least one ticket may comprise at least two tickets and the quantity of the at least two tickets may depend on the quantity of the one or more items in the order. For instance, if the order comprises two items (a first item and a second item), the at least two tickets may comprise exactly three tickets. In such an exemplary embodiment, a first ticket may comprise the identity information and a quantity of the one or more items, a second ticket may comprise the first item in the order, and a third ticket may comprise the second item in the order.

A person of ordinary skill in the art will understand that the at least one ticket may comprise exactly one ticket or more than two tickets and that each of such at least one tickets may comprise selection or combination of the identity information and the order. Moreover, the at least one ticket may ensure that the business delivers the order to the proper customer, that is, the customer associated with the identity information on the at least one ticket. In certain embodiments, the printer may be further operative to automatically print the at least one ticket. In further such embodiments, the printer may automatically print the at least one ticket responsive to the preparation timeframe arrival of the customer. More particularly, in some embodiments wherein the at least one ticket may comprise at least two tickets (a first ticket and a second ticket), the printer may automatically print the first ticket when the business computing device 104 receives the order. Then, the printer may automatically print the second ticket responsive to the preparation timeframe arrival of the customer.

In further embodiments, the business computing device 104 may be further operative to adjust operating hours, which may comprise one or more hours during which the business is able and willing to receive the order. In certain such embodiments, the operating hours may be adjusted for each day of a week or may be standardized for each day. Thus, the operating hours per day may be identical or vary. In some embodiments, the business may manually turn off the operating hours in real-time.

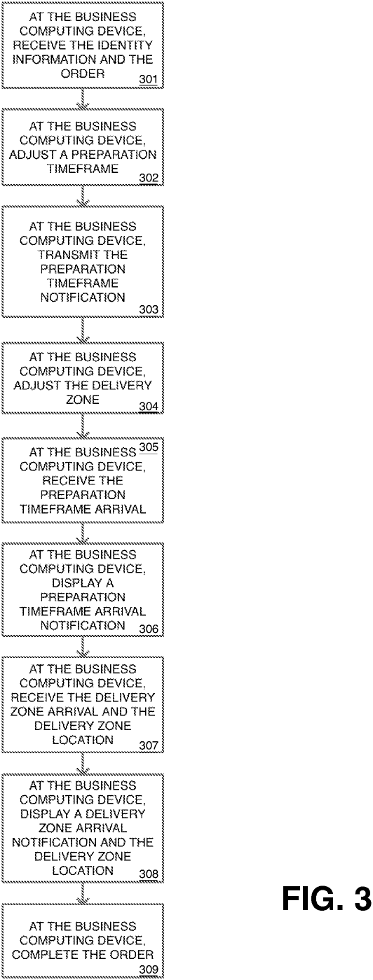

FIGS. 2 and 3 are flowcharts depicting an exemplary embodiment of system and method for order retrieval, such as may be performed by the customer mobile computing device 102 and the business computing device 104 of FIG. 1. As shown in FIG. 2, the method may include the steps of: providing a mobile computing device associated with a customer and a computing device associated with a business (block 201); receiving, at the customer mobile computing device, identity information associated with the customer (block 202); generating, at the customer mobile computing device, a menu comprising one or more items associated with the business (block 203); receiving, at the customer mobile computing device, an order comprising at least one of the one or more items (block 204); transmitting, at the customer mobile computing device, the identity information and the order to the business (block 205); detecting, at the customer mobile computing device, an initial location associated with the customer (block 206); receiving, at the customer mobile computing device, a preparation timeframe notification from the business (block 207); providing, at the customer mobile computing device, navigational directions from the initial location to a delivery zone (block 208); detecting, at the customer mobile computing device, a preparation timeframe arrival of the customer (block 209); transmitting, at the customer mobile computing device, the preparation timeframe arrival to the business (block 210); detecting, at the customer mobile computing device, a delivery zone arrival of the customer (block 211); detecting, at the customer mobile computing device, a delivery zone location of the customer (block 212); and transmitting, at the customer mobile computing device, the delivery zone arrival and the delivery zone location to the business (block 213).

As shown in FIG. 3, the method may further include the steps of: receiving, at the business computing device, the identity information and the order (block 301); adjusting, at the business computing device, a preparation timeframe (block 302); transmitting, at the business computing device, the preparation timeframe notification to the customer based on the preparation timeframe (block 303); adjusting, at the business computing device, the delivery zone (block 304); receiving, at the business computing device, the preparation timeframe arrival (block 305); displaying, at the business computing device, a preparation timeframe arrival notification (block 306); receiving, at the business computing device, the delivery zone arrival and the delivery zone location (block 307); displaying, at the business computing device, a delivery zone arrival notification and the delivery zone location (block 308); and completing, at the business computing device, the order (block 309).

Receiving the identity information (block 202) may alternatively or in combination comprise receiving the identity information directly via input from the customer or from the customer mobile computing device 102. In addition, receiving the identity information may further comprise receiving the identity information from one or more applications stored on the customer computing device 102, such as, for example, a social media application. In embodiments wherein the customer may be a returning customer of the business, the identity information may be prestored.

In some embodiments, detecting an initial location associated with the customer (block 206) may comprise receiving input from the customer regarding the initial location. In alternate embodiments, detecting an initial location (block 206) may comprise using GPS or other means to determine the location of the customer mobile computing device 102 and therefore, the customer associated with said device 102. Providing navigational directions from the initial location to a delivery zone (block 208) may comprise providing said directions directly or linking to another application stored on the computing device 102 wherein the directions may be provided. Moreover, providing the navigational directions (block 208) may further comprise displaying an image, such as a map, depicting a route, which may comprise the proposed path along which the customer may travel to the delivery zone. Alternatively, providing the navigational directions (block 208) may further comprise displaying text depicting the route.

Detecting a preparation timeframe arrival of the customer (block 209) may further comprise detecting that the customer is physically present at a GPS coordinate along the route such that the customer is likely to arrive in the delivery zone within a minimum amount of time. The minimum amount of time may comprise may comprise the smallest increment amount of time required by the business to prepare the order. In some embodiments, detecting a preparation timeframe arrival of the customer (block 209) may comprise continuously receiving, at the business computing device 104, one or more GPS coordinates of the customer as the customer travels along the route to the business. Transmitting, at the customer mobile computing device 102, the preparation timeframe arrival to the business (block 210), subsequently receiving, at the business computing device 104, the preparation timeframe arrival (block 305) and displaying, at the business computing device 104, the preparation timeframe arrival notification (block 306) may alert the business in sufficient time to prepare the order within the preparation timeframe.

Similar to detecting a preparation timeframe arrival of the customer (block 209), detecting a delivery zone arrival (block 211) and a delivery zone location of the customer (block 211) may further comprise detecting that the customer is physically present at a GPS coordinate within the delivery zone. Additionally, detecting the delivery zone location of the customer (block 212) may comprise detecting a GPS coordinate of the customer within the delivery zone. In certain embodiments, detecting the delivery zone location (block 212) may comprise detecting a parking space where the customer is parked within the delivery zone.

Receiving the identity information and the order (block 301) may further comprise receiving a ticket listing the identity information and the order. In certain embodiments, receiving the identity information and receiving the order may occur separately, that is, the order may be received and then the identity information may be received, or vice versa. The identity information may comprise personal information, which may relate to the customer, and vehicular information, which may relate to a vehicle of the customer. More particularly, the vehicular information may assist the business in locating the customer within the delivery zone. Also, the identity information may allow the business to associate the order of a particular customer with said particular customer. The identity information may include financial information, which may also allow the business to charge the customer for the order.

According to certain embodiments, adjusting a preparation timeframe (block 302) may further comprise determining a minimum amount of time needed to prepare the order and setting the preparation timeframe accordingly. Specifically, if the order comprises one item, a few items, or is relatively simple, the preparation timeframe may be adjusted downward. Oppositely, if the order comprises more than one item or is relatively complicated, the preparation timeframe may be adjusted upward. Moreover, adjusting the preparation timeframe (block 302) may further depend on the level of traffic at the business. In particular, if the business is busy when the order is received, the preparation timeframe may be adjusted upward to account for other customers and their respective orders. Further, adjusting the preparation timeframe (block 302) may comprise receiving one or more preparation status updates from the business.

Adjusting the delivery zone (block 304) may further comprise receiving a customized map. The customized map may comprise one or more GPS coordinates. In some embodiments, the business may create the customized map. Indeed, the customized map may be configured as any size or shape. In such embodiments, the one or more GPS coordinates may correspond to a parking lot or a parking garage associated with or near to the business. In other embodiments, the one or more GPS coordinates may correspond to a curb or nearby temporary parking area.

Receiving the delivery zone arrival and the delivery zone location (block 307) and displaying a delivery zone arrival notification and the delivery zone location (block 308) may comprise alerting the business that the customer has arrived within the delivery zone and showing, in a viewable format, the delivery zone location of the customer. In some embodiments, displaying the delivery zone location (block 308) may comprise displaying an image, such as a map, depicting one or more GPS coordinates of the customer within the delivery zone. In other embodiments, displaying the delivery zone location (block 308) may comprise displaying text depicting the one or more GPS coordinates of the customer within the delivery zone.

Finally, completing the order (block 309) may comprise delivering the order to the customer. In other embodiment, completing the order (block 309) may further comprise charging the customer for the order. The customer may be charged for the order using the financial information. In additional embodiments, completing the order (block 309) may comprise transmitting a rating request to the customer. The rating request may comprise one or more categories for review by the customer, including ease of delivery, speed of delivery, quality of the one or more items of the order, etc. In further embodiments, completing the order (block 309) may comprise charging the customer for the order only after the order has been delivered to the customer. In still alternate embodiments, completing the order (block 309) may comprise placing the order in a retrieval location.

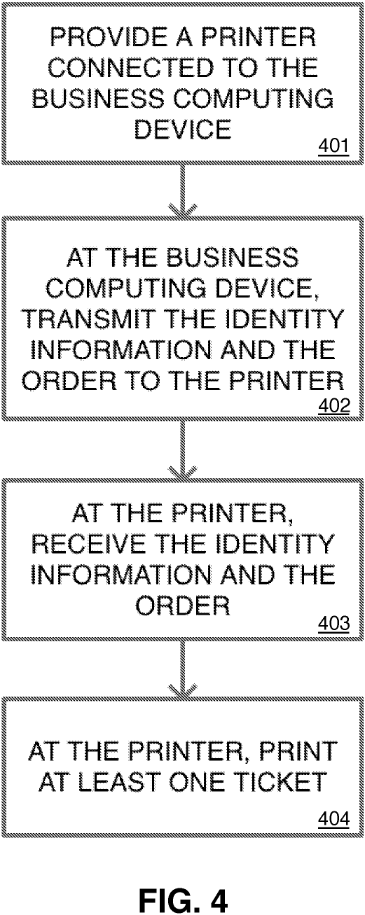

FIG. 4 is a flowchart depicting an exemplary embodiment of system and method for order retrieval, such as may be performed by the customer mobile computing device 102 and the business computing device 104 of FIG. 1, in addition to a printer. As shown in FIG. 4, the method may include the steps of: providing the printer connected to the computing device associated with the business (block 401); transmitting, at the business computing device, the identity information and the order to the printer (block 402); receiving, at the printer, the identity information and the order (block 403); and printing, at the printer, at least one ticket (block 404).

If embodied in software, it should be noted that each block depicted in the accompanying flowcharts represents a module, segment, or portion of code that comprises program instructions stored on a non-transitory computer readable medium to implement the specified logical function(s). In this regard, the program instructions may be embodied in the form of source code that comprises statements written in a programming language or machine code that comprises numerical instructions recognizable by a suitable execution system such as the customer mobile computing device 102 and the business computing device 104. The machine code may be converted from the source code, etc. If embodied in hardware, each block may represent a circuit or a number of interconnected circuits to implement the specified logical function(s). Additionally, although the flowcharts show specific orders of execution, it is to be understood that the orders of execution may differ.

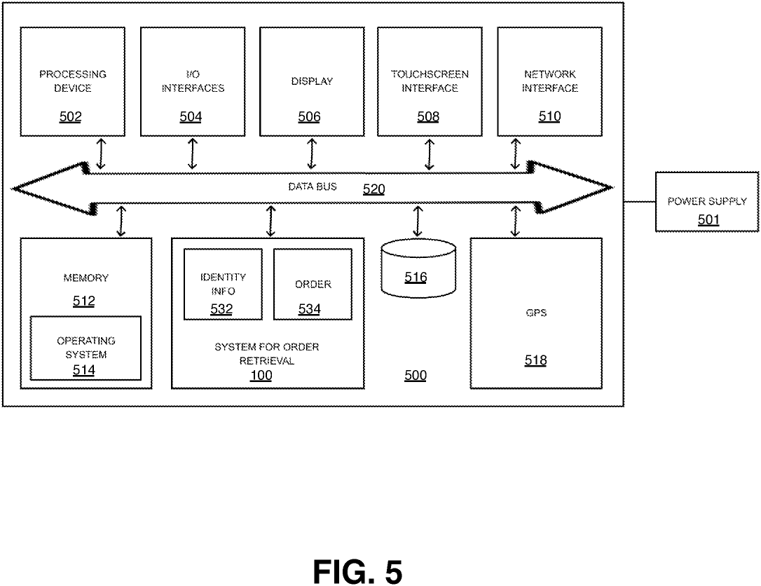

FIG. 5 illustrates an exemplary customer mobile computing device 500 configured to implement the order retrieval system. As described earlier, the mobile computing device 500 may be a tablet computer or smartphone but may also be embodied in any one of a wide variety of wired and/or wireless computing devices known to those skilled in the art. As shown in FIG. 5, the mobile computing device 500 may include a processing device (processor) 502, input/output interfaces 504, a display 506, a touchscreen interface 508, a network interface 510, a memory 512, and operating system 514, a mass storage 516 and a GPS 518, with each communicating across a local data bus 520. Additionally, the customer mobile device 500 may incorporate a system for order retrieval 100, which is depicted as including identity information 532 and the order 534, although the location of information 532 and 534 may vary. The mobile computing device 500 may further comprise a power supply 501.

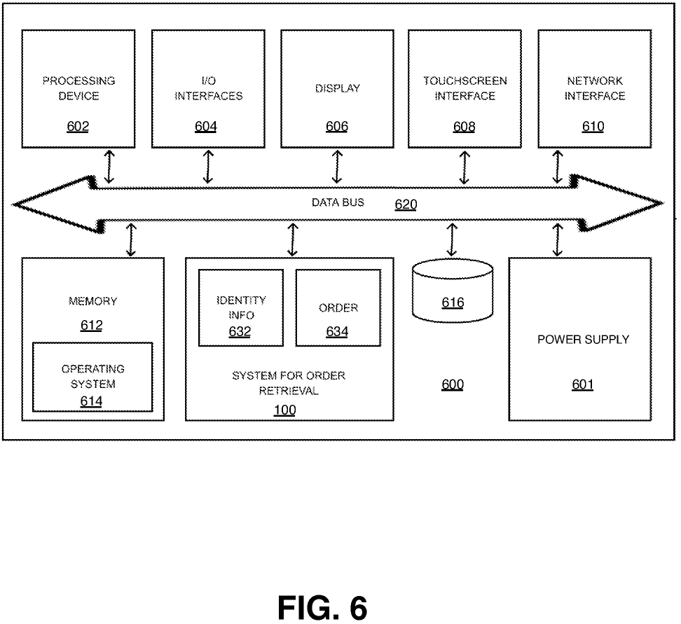

FIG. 6 depicts an exemplary business computing device 600 configured to implement the order retrieval system. Business computing device 600 may include a processing device (processor) 602, input/output interfaces 604, a display 606, a touchscreen interface 608, and a network interface 610, a memory 612, an operating system 614, and a mass storage 616, with each communicating across a local data bus 620. Further, the business computing device 600 may be coupled to a power supply 601. Additionally, the business computing device 600 may incorporate a system for order retrieval 100, which is depicted as including identity information 632 and the order 634, although the location of information 632 and 634 may vary. The business computing device 600 may further comprise a power supply 601.

The processing devices 502, 602 may include any custom made or commercially available processor, a central processing unit (CPU) or an auxiliary processor among several processors associated with the mobile computing device 500 and the business computing device 600, a semiconductor based microprocessor (in the form of a microchip), a macroprocessor, one or more application specific integrated circuits (ASICs), a plurality of suitably configured digital logic gates, and other electrical configurations comprising discrete elements both individually and in various combinations to coordinate the overall operation of the system.

The memory 512, 612 may include any one of a combination of volatile memory elements (e.g., random-access memory (RAM, such as DRAM, and SRAM, etc.)) and nonvolatile memory elements. The memory may typically comprise native operating system 514, 614 one or more native applications, emulation systems, or emulated applications for any of a variety of operating systems and/or emulated hardware platforms, emulated operating systems, etc. For example, the applications may include application specific software which may comprise some or all the components of the customer mobile computing device 500 or the business computing device 600. In accordance with such embodiments, the components are stored in memory and executed by the processing device. Note that although depicted separately in FIGS. 5 and 6, the system and method for order retrieval 100 may be resident in memory such as memory 512, 612.

Touchscreen interface 508, 608 is configured to detect contact within the display area of the display 506, 606, respectively, and provides such functionality as on-screen buttons, menus, keyboards, etc. that allows users to navigate user interfaces by touch. For instance, touchscreen interface 508, 608 may allow users to input the identity information and navigate the menu, thereby further allowing users to input the order. For some embodiments, the mobile device 500 may comprise GPS 518 or other means to determine the location of the mobile computing device 500.

One of ordinary skill in the art will appreciate that the memory 512, 612 can, and typically will, comprise other components which have been omitted for purposes of brevity. Note that in the context of this disclosure, a non-transitory computer-readable medium stores one or more programs for use by or in connection with an instruction execution system, apparatus, or device. With further reference to FIGS. 5 and 6, network interface device 510, 610 may comprise various components used to transmit and/or receive data over a networked environment such as depicted in FIG. 1. When such components are embodied as an application, the one or more components may be stored on a non-transitory computer-readable medium and executed by the processing device.

It should be emphasized that the above-described embodiments are merely examples of possible implementations. Many variations and modifications may be made to the above-described embodiments without departing from the principles of the present disclosure. All such modifications and variations are intended to be included herein within the scope of this disclosure and protected by the following claims.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

### CONCLUSIONS, RAMIFICATIONS, AND SCOPE

While certain embodiments of the invention have been illustrated and described, various modifications are contemplated and can be made without departing from the spirit and scope of the invention. For example, the system and method for order retrieval may be utilized by any type of business, including those that provide services or a combination of goods and services. Accordingly, it is intended that the invention not be limited, except as by the appended claims.

The teachings disclosed herein may be applied to other systems, and may not necessarily be limited to any described herein. The elements and acts of the various embodiments described above can be combined to provide further embodiments. All of the above patents and applications and other references, including any that may be listed in accompanying filing papers, are incorporated herein by reference. Aspects of the invention can be modified, if necessary, to employ the systems, functions and concepts of the various references described above to provide yet further embodiments of the invention.

Particular terminology used when describing certain features or aspects of the invention should not be taken to imply that the terminology is being refined herein to be restricted to any specific characteristics, features, or aspects of the system and method for order retrieval with which that terminology is associated. In general, the terms used in the following claims should not be constructed to limit the system and method for order retrieval to the specific embodiments disclosed in the specification unless the above description section explicitly define such terms. Accordingly, the actual scope encompasses not only the disclosed embodiments, but also all equivalent ways of practicing or implementing the disclosed system, method and apparatus. The above description of embodiments of the system and method for order retrieval is not intended to be exhaustive or limited to the precise form disclosed above or to a particular field of usage.

While specific embodiments of, and examples for, the method, system, and apparatus are described above for illustrative purposes, various equivalent modifications are possible for which those skilled in the relevant art will recognize.

While certain aspects of the method and system disclosed are presented below in particular claim forms, various aspects of the method, system, and apparatus are contemplated in any number of claim forms. Thus, the inventor reserves the right to add additional claims after filing the application to pursue such additional claim forms for other aspects of the system and method for order retrieval.

What is claimed is:

1. An order retrieval system, comprising:
a mobile computing device associated with a customer, operative to
receive identity information associated with the customer;
generate a menu comprising one or more items associated with a business;
receive an order comprising at least one of the one or more items;
transmit the identity information and the order to the business;
detect an initial location associated with the customer;
receive a preparation timeframe notification from the business;
provide navigational directions from the initial location to a delivery zone;
detect a preparation timeframe arrival of the customer;
transmit the preparation timeframe arrival to the business;
detect a delivery zone arrival of the customer;
detect a delivery zone location of the customer;
transmit the delivery zone arrival and the delivery zone location to the business;
a computing device associated with the business, operative to
receive the identity information and the order;
adjust a preparation timeframe;
transmit the preparation timeframe notification to the customer based on the preparation timeframe;
adjust the delivery zone;
receive the preparation timeframe arrival;
display a preparation timeframe arrival notification;
receive the delivery zone arrival and the delivery zone location;
display a delivery zone arrival notification and the delivery zone location; and
complete the order.

2. The order retrieval system of claim 1, wherein the identity information comprises personal information and vehicular information.

3. The order retrieval system of claim 1, wherein the business is a restaurant or a retail store.

4. The order retrieval system of claim 1, wherein the preparation timeframe is adjusted based on a minimum amount of time needed for the business to prepare the order or one or more preparation status updates from the business.

5. The order retrieval system of claim 1, wherein the delivery zone is customizable by the business.

6. The order retrieval system of claim 5, wherein the delivery zone is a parking lot associated with the business.

7. The order retrieval system of claim 1, wherein the delivery zone location is one or more global positioning system (GPS) coordinates of the customer within the delivery zone.

8. The order retrieval system of claim 1, further comprising a printer connected to the computing device associated with the business, wherein the computing device is further operative to transmit the identity information and the order to the printer, and wherein the printer is operative to
receive the identity information and the order; and
print at least one ticket comprising the identity information and the order.

9. The order retrieval system of claim 8, wherein the at least one ticket comprises a first ticket and a second ticket, and wherein the first ticket comprises the identity information and a quantity of the one or more items, and the second ticket comprises the one or more items.

10. A method for order retrieval, comprising
providing a mobile computing device associated with a customer and a computing device associated with a business;
at the mobile computing device associated with the customer,
receiving identity information associated with the customer;
generating a menu computing one or more items associated with the business;
receiving an order comprising at least one of the one or more items;
transmitting the identity information and the order to the business;
detecting an initial location associated with the customer;
receiving a preparation timeframe notification from the business;
providing navigational directions from the initial location to a delivery zone;
detecting a preparation timeframe arrival of the customer;
transmitting the preparation timeframe arrival to the business;
detecting a delivery zone arrival of the customer;
detecting a delivery zone location of the customer;
transmitting the delivery zone arrival and the delivery zone location to the business;
at the computing device associated with the business,
receiving the identity information and the order;
adjusting a preparation timeframe;
transmitting the preparation timeframe notification to the customer based on the preparation timeframe;
adjusting the delivery zone;
receiving the preparation timeframe arrival;
displaying a preparation timeframe arrival notification;
receiving the delivery zone arrival and the delivery zone location;
displaying a delivery zone arrival notification and the delivery zone location; and
completing the order.

11. The method of claim 10, wherein adjusting the preparation timeframe further comprises determining a minimum amount of time needed for the business to prepare the order or receiving one or more preparation status updates from the business.

12. The method of claim 10, wherein adjusting the delivery zone further comprises receiving a customized map, and wherein the customized map comprises one or more GPS coordinates.

13. The method of claim 10, further comprising
providing a printer connected to the computing device associated with the business;
at the computing device associated with the business,
transmitting the identity information and the order to the printer; at the printer,
receiving the identity information and the order; and
printing at least one ticket.

14. The method of claim 13 wherein the at least one ticket comprises a first ticket and a second ticket, and wherein the first ticket comprises the identity information and a quantity of the one or more items, and the second ticket comprises the one or more items.

15. The method of claim 10, wherein completing the order further comprises charging the customer for the order.

16. A non-transitory, tangible computer-readable medium having stored thereon computer-executable instructions, which, when executed by a computer processor, enable performance of a method comprising:
providing a customer mobile computing device and a business computing device;
receiving, at the customer mobile computing device, identifying information associated with the customer;
generating, at the customer mobile computing device, a menu computing one or more items associated with the business;
receiving, at the customer mobile computing device, an order comprising at least one of the one or more items;
transmitting, at the customer mobile computing device, the order to the business;
detecting, at the customer mobile computing device, an initial location associated with the customer;
receiving, at the customer mobile computing device, a preparation timeframe notification from the business;
providing, at the customer mobile computing device, navigational directions to the delivery zone;
detecting, at the customer mobile computing device, a preparation timeframe arrival of the customer;
transmitting, at the customer mobile computing device, the preparation timeframe arrival to the business;
detecting, at the customer mobile computing device, a delivery zone arrival of the customer;
detecting, at the customer mobile computing device, a delivery zone location of the customer;
transmitting, at the customer mobile computing device, the delivery zone arrival and the delivery zone location to the business;
receiving, at the business computing device, the identifying information and the order;
adjusting, at the business computing device, a preparation timeframe;
transmitting, at the business computing device, the preparation timeframe notification to the customer based on the preparation timeframe;
adjusting, at the business computing device, the delivery zone;
receiving, at the business computing device, the preparation timeframe arrival;
displaying, at the business computing device, a preparation timeframe arrival notification;
receiving, at the business computing device, the delivery zone arrival and the delivery zone location;
displaying, at the business computing device, a delivery zone arrival notification and the delivery zone location; and
completing, at the business computing device, the order.

17. The medium of claim 16, wherein adjusting, at the business computing device, the preparation timeframe further comprises determining a minimum amount of time needed for the business to prepare the order or receiving one or more preparation status updates from the business.

18. The medium of claim 16, wherein adjusting, at the business computing device, the delivery zone further comprises receiving a customized map, and wherein the customized map comprises one or more GPS coordinates.

19. The medium of claim 16, wherein the method further comprises
providing a printer connected to the business computing device;
transmitting, at the business computing device, the identity information and the order to the printer;
receiving, at the printer, the identity information and the order; and
printing, at the printer, at least one ticket.

20. The medium of claim 19, wherein the at least one ticket comprises a first ticket and a second ticket, and wherein the first ticket comprises the identity information and a quantity of the one or more items, and the second ticket comprises the one or more items.
